(19) United States
(12) Patent Application Publication
(10) Pub. No.: US 2004/0140165 A1
(43) Pub. Date: Jul. 22, 2004

(54) Backing plate with friction material retention members and method and apparatus for manufacturing same

(76) Inventor: Nghi Pham, Ontario (CA)

Correspondence Address: WHITE & CASE LLP, PATENT DEPARTMENT, 1155 AVENUE OF THE AMERICAS, NEW YORK, NY, 10036, US

(21) Appl. No.: 10/346,907

(22) Filed: Jan. 17, 2003

(51) Int. Cl. F16D 65/78

(52) U.S. Cl. 188/218 XL

(57) ABSTRACT

A backing plate for a friction assembly includes a body having a first surface and a second surface. On or more retention members are provided on the first surface for engaging a friction material mounted thereon. Each retention member has a primary depressed portion and a secondary depressed portion and one or more protruding members extending upwardly from the first surface. The protruding members are formed by extrusion or cutting the plate material from the side wall of the primary depressed portion.

### FIELD OF THE INVENTION

This invention relates to friction assemblies suitably used with brakes on vehicles, and more particularly to a backing plate and method and apparatus for manufacturing same.

### BACKGROUND OF THE INVENTION

A friction assembly is a replaceable element in a brake system. In a disk brake, a friction assembly bears against a rotating disc called a rotor. The friction assembly comprises a backing plate to which a friction pad is adhered. The friction pad alone contacts the rotor of the disc brake to provide the stopping frictional force. Significant forces are involved in applying the pad to the rotor, and due to the relative movement during engagement, extreme temperature can be generated up to about 1200° F. Moreover, depending upon the size and/or the payload carried by certain vehicles, the friction assembly bears with significant pressure and vibration when stopping vehicles. It is very important that the backing plate is resistant to bending or breaking due to high pressure, temperature and vibration when stopping vehicles.

Typically, backing plates are modified to include bores, cavities, gouges or protuberances to receive and engage the friction material. These modifications generally improve engagement with a friction material. However, the costs associated with manufacturing backing plates with such modification can often be prohibitive.

It is therefore desirable to provide a backing plate having improved engagement with a friction material without involving undue manufacturing costs.

### SUMMARY OF THE INVENTION

The present invention uses one or more retention members formed on a surface of a backing plate for engaging a friction material. Each retention member comprises a primary depression and one or more protruding members formed from the side wall of the primary depression.

In accordance with an embodiment of the invention, there is provided a backing plate for a friction assembly. The backing plate comprises a body having a first surface for receiving a friction material thereon and a second surface opposed to the first surface, and one or more retention members defined on the first surface. Each retention member has primary depression defined on the first surface of the body and having a side wall that extends inwardly from the first surface towards the second surface, one or more secondary depressions, each extending along the first surface of the body between a first end and a second end, the first end merging into the side wall of the primary depression, and one or more protruding members, each extending outwardly from the first surface of the body at the second end of each secondary depression.

In accordance with another embodiment of the invention, there is provided a friction assembly for a brake assembly. The friction assembly comprises a backing plate having a body having a first surface for receiving a friction material thereon and a second surface opposed to the first surface, and one or more retention members defined on the first surface. Each retention member has a primary depression defined on the first surface of the body and having a side wall that extends inwardly from the first surface towards the second surface, one or more secondary depressions, each extending along the first surface of the body between a first end and a second end, the first end merging into the side wall of the primary depression, and one or more protruding members, each extending outwardly from the first surface of the body at the second end of each secondary depression; and a friction material mounted on the first surface of the backing plate so that the friction material is engaged with the at least one retention member.

In accordance with another embodiment of the invention, there is provided a method for making a backing plate for a friction assembly. The method comprises steps of forming a primary depression on a first surface of a body for receiving a friction material thereon, the primary depression defining a side wall extending inwardly from the first surface towards the second surface, and forming a secondary depression from the side wall of the primary depression to extend along the first surface between a first end and a second end, and a protruding member at the second end of the secondary depression to extend outwardly from the first surface.

In accordance with another embodiment of the invention, there is provided a retention member formation apparatus for forming one or more retention members on a backing plate material. The apparatus comprises a primary depression forming apparatus for forming one or more primary depressions on a first surface of a backing plate material which receives a friction material, each primary depression having a bottom and a side wall surrounding the bottom; and a protruding member forming apparatus for forming from the side wall of the primary depression a secondary depression that extends along the first surface between a first end and a second end, and a protruding member at the second end of the secondary depression to extend outwardly from the first surface.

In accordance with another embodiment of the invention, there is provided a retention member formation apparatus for forming one or more retention members on a backing plate material. The apparatus comprises a primary depression forming apparatus for forming one or more primary depressions on a first surface of a backing plate material which receives a friction material, each primary depression having a bottom and a side wall surrounding the bottom; and a cutting apparatus for cutting plate material from the side wall of the primary depression to form a secondary depression that extends along the first surface between a first end and a second end, and a protruding member at the second end of the secondary depression to extend outwardly from the first surface and curled away from the primary depression.

### BRIEF DESCRIPTION OF THE DRAWINGS

For a better understanding of the present invention, and to show more clearly how it may be carried into effect, reference will now be made by way of example to the accompanying drawings. The drawings show preferred embodiments of the present invention, in which:

FIG. 1 is a perspective view of a friction assembly in accordance with an embodiment of the present invention;

FIG. 2 is a perspective view of a backing plate for the friction assembly of FIG. 1;

FIG. 3 shows a portion of the backing plate of FIG. 2 after sectional along line 3-3;

FIG. 4A is an enlarged perspective view of a retention member for the backing plate of FIG. 2;

FIG. 4B is a side view of the retention member for the backing plate of FIG. 4A;

FIG. 5 is a cross-sectional side view of an apparatus for forming one or more retention members in the backing plate in accordance with an embodiment of the present invention;

FIG. 6 is a cross-sectional section view of a tool assembly for forming grooves on a backing plate;

FIG. 7A is a cross-sectional section view of an apparatus for forming material to form claws at a die opening position;

FIG. 7B is a cross-sectional view of the apparatus at a die closing position;

FIG. 8A is a schematic front view of a punching tool;

FIG. 8B is a schematic side view of a punching tool;

FIG. 9 is schematic side view of an extruding and curling tool;

FIGS. 10A to 10D are schematic partial views of the extruding and curling tool and the plate material showing steps of extrusion and curling;

FIG. 11 is a perspective view of a backing plate showing another embodiment of the present invention for the friction assembly of FIG. 1;

FIG. 12 shows a portion of the backing plate of FIG. 11 sectional along line 13-13;

FIG. 13 is an enlarge perspective view of a retention member of the backing plate of FIG. 11;

FIG. 14 is schematic side view of a cutting and curling tool; and

FIG. 15 is a schematic plan view of a backing plate in accordance with another embodiment of the present invention.

### DETAILED DESCRIPTION OF THE PREFERRED EMBODIMENTS

An embodiment of the present invention provides a backing plate with one or more retention members for engaging a friction material. Each retention member comprises a primary depression and one or more protrusion members associated with the primary depression. Each protrusion member has its corresponding secondary depression that is connected to the primary depression. Each protrusion extends outwardly away from the surface of the backing plate. Multiple protrusion members associated with a same primary depression are curled in more than one direction. The backing plate of this embodiment is intended for use with a disc brake. However, the present invention may be applied to different types of brakes with or without modifications.

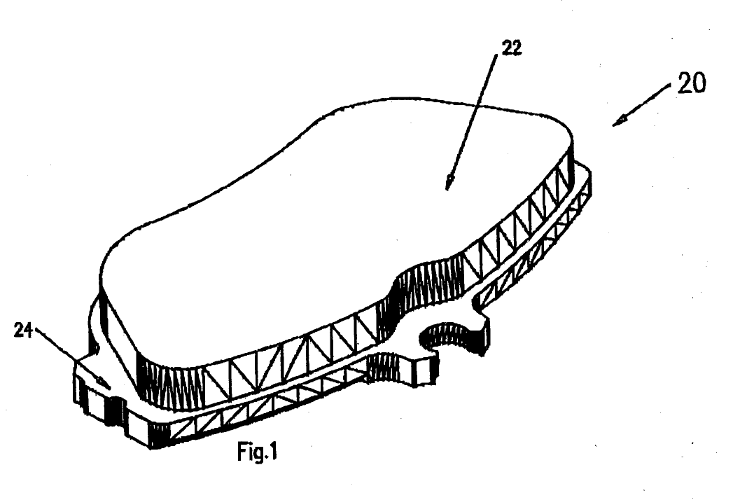

FIG. 1 generally shows a friction assembly 20 in accordance with an embodiment of the present invention. Friction assembly 20 includes a friction material 22 and a backing plate 24. Friction material 22 is usually made of phenolic resin with iron powder, steel or carbon fibers, and/or carbon powder. Friction material 22 is mounted on backing plate 24, e.g., molded in a known manner to backing plate 24.

Backing plate 24 is formed of metal, a metal composite or such other material that is suitable for the intended use of the friction assembly 20 and that may be processed in accordance with the method described below. Backing plate 24 is of a conventional shape and thickness, and may include apertures and other structural elements known in the art to permit backing plate to be incorporated within a brake assembly (not shown).

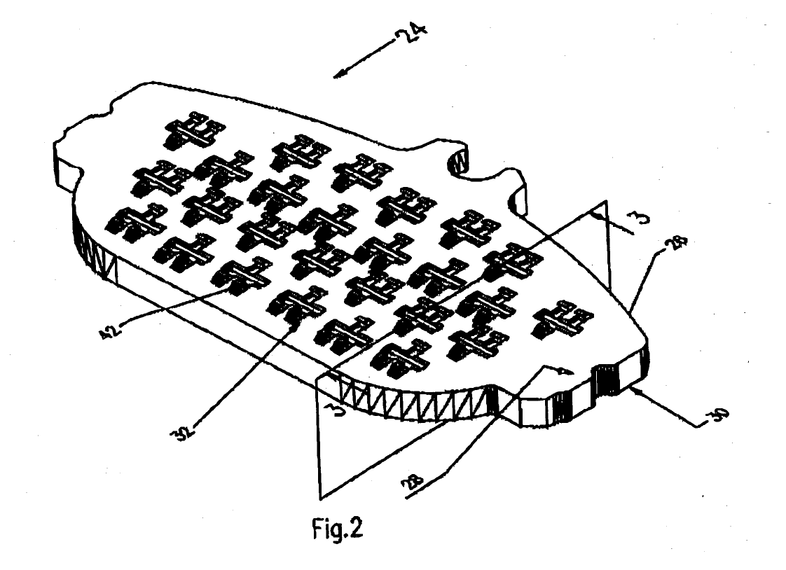

Referring to FIGS. 2-4B, backing plate 24 is further described in detail.

Backing plate 24 has a body 26 with a planar top or first surface 28 and an opposing planar bottom or second surface 30. First surface 28 defines one or more retention members 32 for engaging friction material 22 once it has been disposed on first surface 28. First surface 28 preferably defines a plurality of retention members 32.

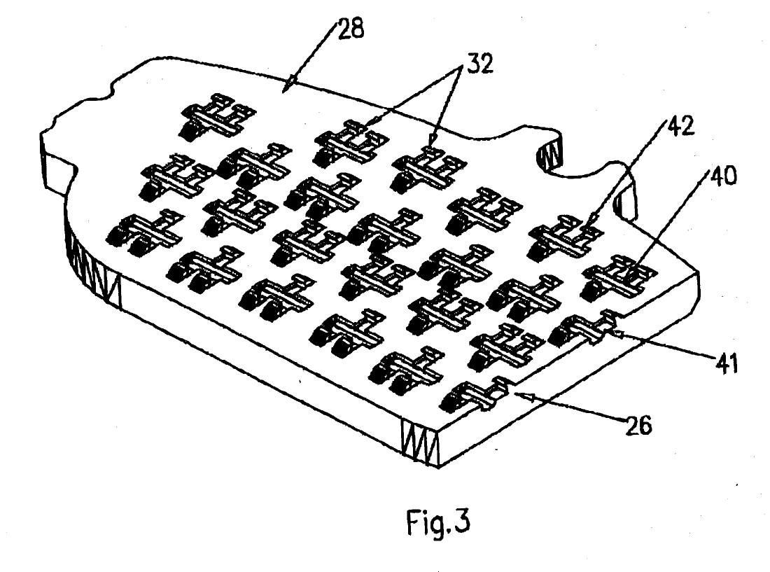

As shown in FIG. 3, each retention member 32 in this embodiment comprises a primary depression or depressed portion 40, three secondary depressions or grooves 41 and three protruding portions or claws 42. The number of grooves 41 and claws 42 may be varied as described below.

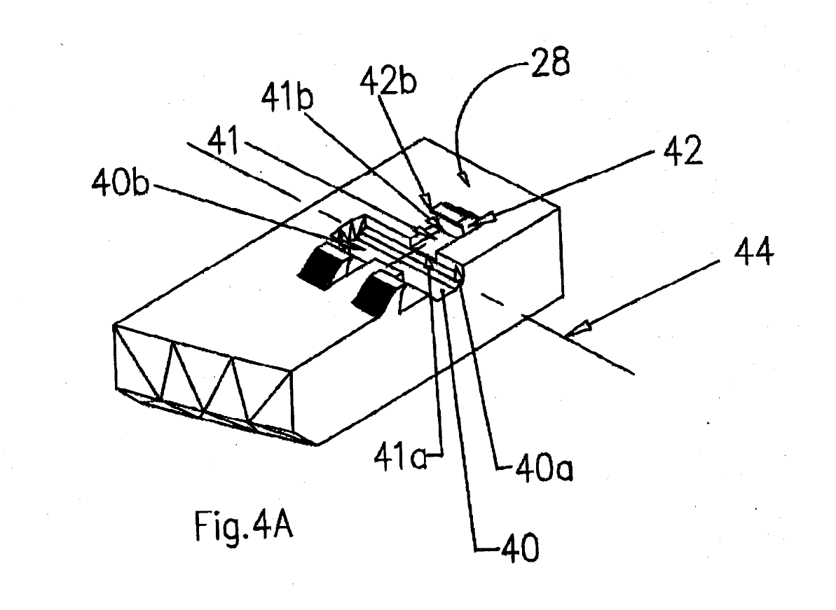

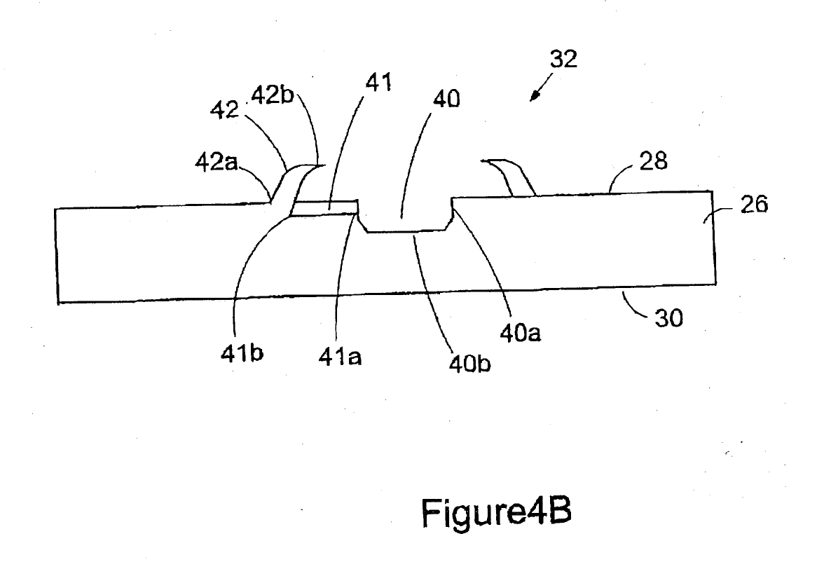

As best seen in FIGS. 4A and 4B, depressed portion 40 has a side wall 40a and a bottom 40b surrounded by side wall 40a. Side wall 40 extends inwardly towards second surface 30 of body 26, i.e., downwardly in FIG. 4B. Side wall 40a and bottom 40b may be continuously formed without a clear boundary. Depressed portion 40 is defined beneath first surface 28 of backing plate 24, i.e., bottom 40b of depressed portion 40 is lower than first surface 28. In FIGS. 2 to 4B, depressed portion 40 has an elongated shape, but it may have a different shape. Different retention members 32 on backing plate 24 may have depressed portions 40 of different shapes. Bottom 40b of depressed portions 40 may be smoothly curved or flat, or made with multiple surfaces. When bottom 40b is divided into multiple-surfaces, retention between friction material 22 and backing plate 24 may be increased.

Each groove 41 is also defined beneath first surface 28 of backing plate 24, i.e., the bottom of each groove 41 is lower than first surface 28. The depth of groove 41 is equal or less than the depth of depressed portion 40. Groove 41 has a first end 41 a and a second end 41b. First end 41a of groove 41 is merged into depressed portion 40 at side wall 40a.

Each protruding portion 42 is formed by an extrusion process further described below. Extruded portions 42 extend outwardly away from first surface 28, i.e., upwardly above first surface 28 in FIG. 4B. Extruded portions 42 are integrally formed with backing plate 24 from the material displaced from associated grooves 41 during the extrusion process. A proximal end 42a of each extruded portion 42 is integrally connected to the first surface 28 of body 26. Extruded portions 42 extend outwardly relative to body 26. A distal end or free end 42b of each extruded portion 42 is curled towards depressed portion 40 over associated groove 41 to form a claw like shape. The curling of free end 42b is in linear relationship with the body of extruded portion 42 and associated groove 41, i.e., extruded portion 42 is not rotated or twisted. Each extruded portion 42 typically extends in the opposite direction to its neighbouring extruded portion or portions 42.

Each extruded portion 42 preferably has a height of between about 0.030-0.075 inches above first surface 28 for backing plates for regular passenger vehicles. For larger vehicles, it is typically desirable to have higher extruded portions 42. Extruded portions 42 may be as high as about 0.100 inch.

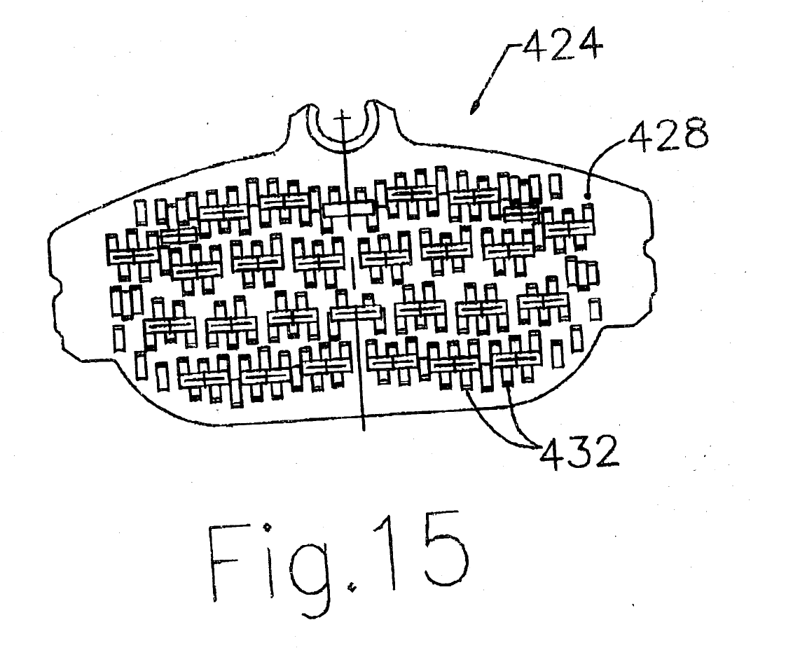

Retention members 32 are arranged on first surface 28 of backing plate 24 in a density and pattern that provides desired retention of friction material 22 while maintaining desired structural integrity of backing plate 24. As shown in FIG. 2, retention members 32 may be arranged in a randomly staggered pattern. The retention members 32 may be arranged in a totally random manner. FIG. 15 shows an example of backing plate 424 having multiple retention members 432 that are arranged randomly on first surface 428 of backing plate 424.

In this embodiment, each retention member 32 has three extrusion portions 42. However, in different embodiments, a retention member may have more or fewer extruded portions 42. Typically, the more extruded portions 42 on each retention member, the stronger is the engagement with the friction material against shearing force, as long as each extruded portion 42 is large and strong enough to withstand forces each extruded portion is expected to receive.

Also, in this embodiment all retention members 32 have the same number of extruded portions 42 extending in opposite directions throughout the backing plate 24. However, it is not necessary to provide retention members 32 that are all the same. A single backing plate may have different retention members.

Also, depressed portion 40 of this embodiment defines a horizontal axis 44 along the length thereof as shown in FIG. 4A. It is preferable that multiple extruded portions 42 alternatively extend in opposite directions about the horizontal axis 44 of their corresponding depressed portion 40. In this embodiment grooves 41 are formed perpendicular to horizontal axis 44 of depressed portion 40. However, in a different embodiment, one or more grooves 41 may be formed with one or more different angles relative to horizontal axis 44 of depressed portion 40. In that embodiment, extruded portions 42 may be curled in various directions, each curled over its corresponding grove 41.

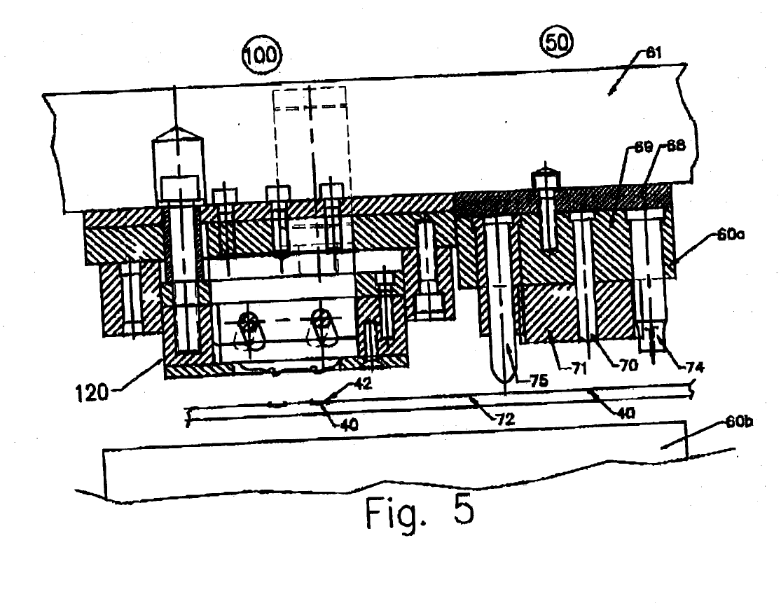

Retention members 32 are preferably manufactured either on a blanked plate or on a strip of incoming material which is being fed into a blanking die. FIG. 5 to FIG. 11 illustrate depression forming apparatus 50 and extrusion apparatus 100 which are suitably used for a two step operation to manufacture retention members 32 on blanked plates or a strip of material in accordance with an embodiment of the invention.

The two step operation comprises:

Step 1: forming depressed portion or portions 40 to prepare for extruding and curling of backing plate material 72; and

Step 2: extruding and curling the material into multiple claws 42 extending from the upper surface of backing plate material 72 about the depressions 40.

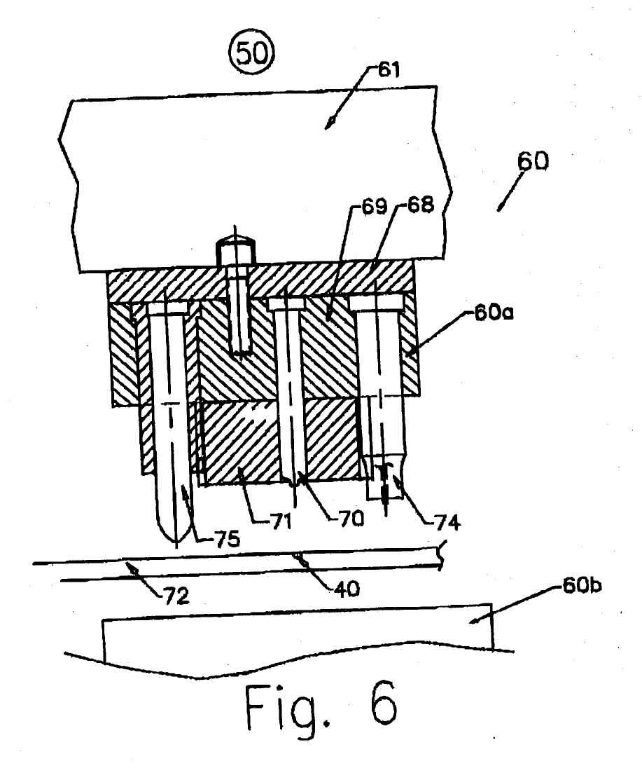

Depression forming apparatus 50 is described referring to FIGS. 5 and 6.

Depression forming apparatus 50 comprises a press die 60 having an upper die 60a and a bottom die 60b. The upper die 60a is mounted to the top die shoe 61 which supports punches 70 by means of punch holder 69 and back up plate 68. The upper die 60a also has a block 71 to determine the depth of depressed portions 40 together with punches 70. Upper die also has two punches 74 to punch holes and two pilots 75 to guide and progress backing plate material 72 into die 60 when a strip of material 72 is fed.

When the upper part of die 61, 68, 69 moves down, punches 70 contact and press into material 72 to form one or more depressed portions 40. At the end of a stroke of the press, these depressed portions 40 divide the contact surface 28 into multi-surfaces to provide increased retention between friction material and backing plate. The pressure by punches 70 compresses the material towards the bottom of the depressed portions 40. These depressed portions 40 can have different shapes and the depths may be varied, as described above. In FIG. 6 the depressed portion 40 is formed as a groove with a flat-bottom shape. The depth is 0.050″.

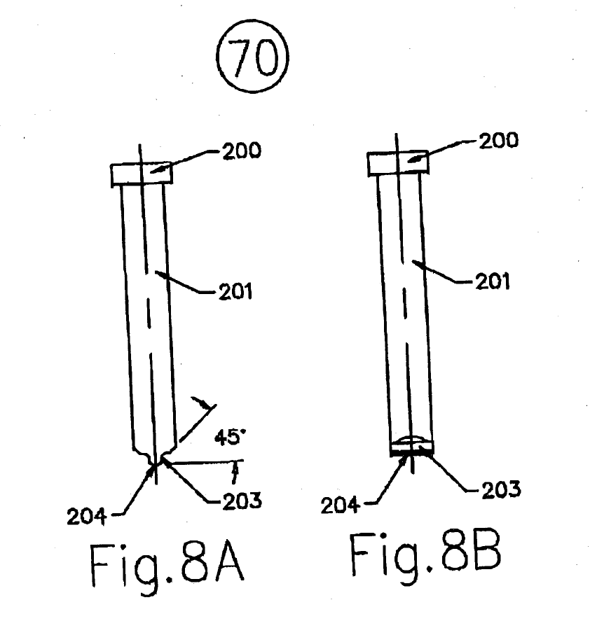

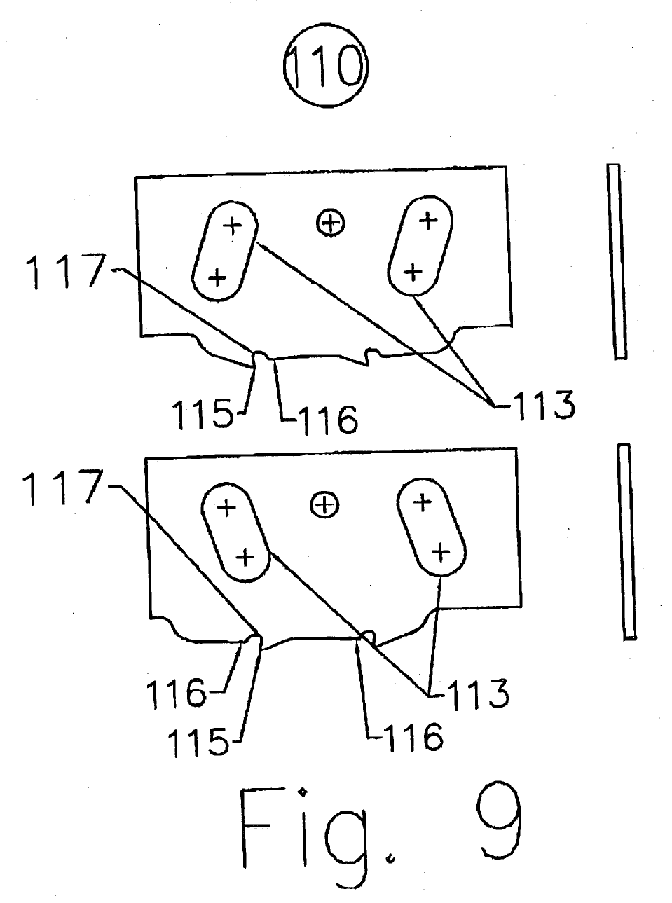

FIGS. 8A and 8B show detail of punch 70 to form depressed portion 40. Punch 70 has a round body 201, a head 200 at an upper end of body 201 and a tip 204 at a lower end of body 201. Tip 204 has a shoulder or side wall 203 that forms side wall 40a of depressed portion 40.

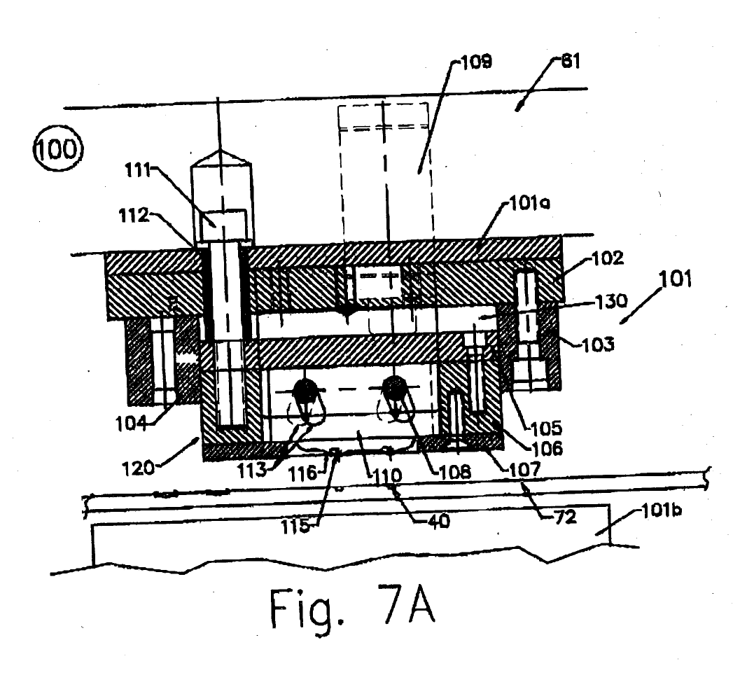

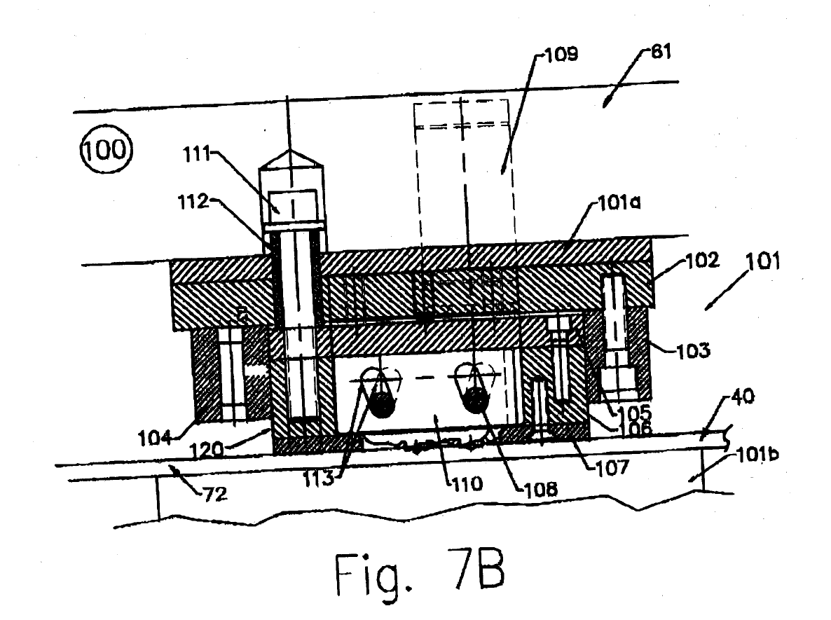

Referring now to FIGS. 5, 7A and 7B, described are extrusion apparatus 100 and the second step of extruding and curling material into multiple protruding members or claws 42.

Extrusion apparatus 100 comprises a press die 101 having an upper die 101a and a bottom die 101b. Upper die 101 a includes. upper die shoe 61 which is commonly used with the depression forming apparatus 50 to synchronize the formation of depressed portion 40 and claws 42. Upper die 101a may have a separate upper die shoe in a different embodiment. Upper die 101 holds extrusion tools assembly 120. Extrusion tool assembly 120 comprises top cover 105 used for supporting extrusion tools 110; housing 106 to hold extrusion tools 110; and bottom cover 107. There are several extrusion tools 110 moving inside of housing 106 in the generally horizontal direction as guided by two pins 108.

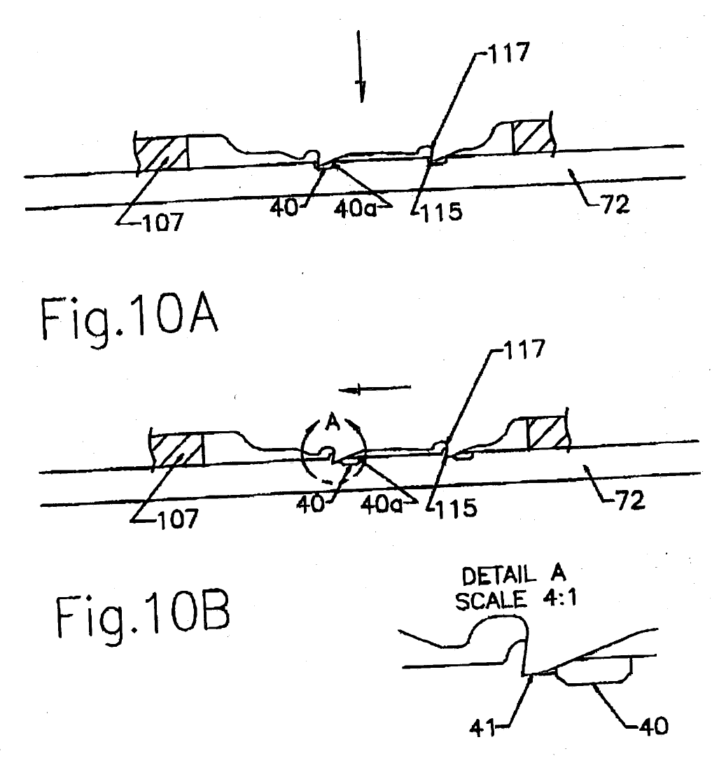

FIG. 9 shows details of two extrusion tools 110. On extrusion tools 110 there are two oblong holes 113 within which two pins 108 (shown in FIGS. 7A and 7B) are movable at an angle to a vertical line. Each extrusion tool 110 has an extrusion edge 115, flat lower edge 116 and concaved section 117 next to extrusion edge 115. Extrusion edge 115 projects below flat edge 116 such that extrusion edge 115 can enter into depressed portion 40. Concaved section 117 receives a portion of the material extruded from the surface of plate material 72 as further described below.

Referring back to FIG. 7A, entire tool assembly 120 is mounted to base plate 102 by screws 111 inside of sleeves 112 which allow tool assembly 120 to move up and down relative to base plate 102. Gas springs 109 keep applying pressure from extrusion edges 115 against material 72 during the extrusion operation. There are two guiding blocks 103 and 104 mounted to base plate 102 to secure tool assembly 120 moving in position. Bottom die 101b has a flat surface to support material 72 thereon.

As shown in FIG. 7A, die 101 is in an open position at the beginning of the press cycle. Gas springs 109 urge tool assembly 120 down to create a gap 130 between base 102 and tool assembly 120. The extrusion tools 110 are in position ready to extrude material 72.

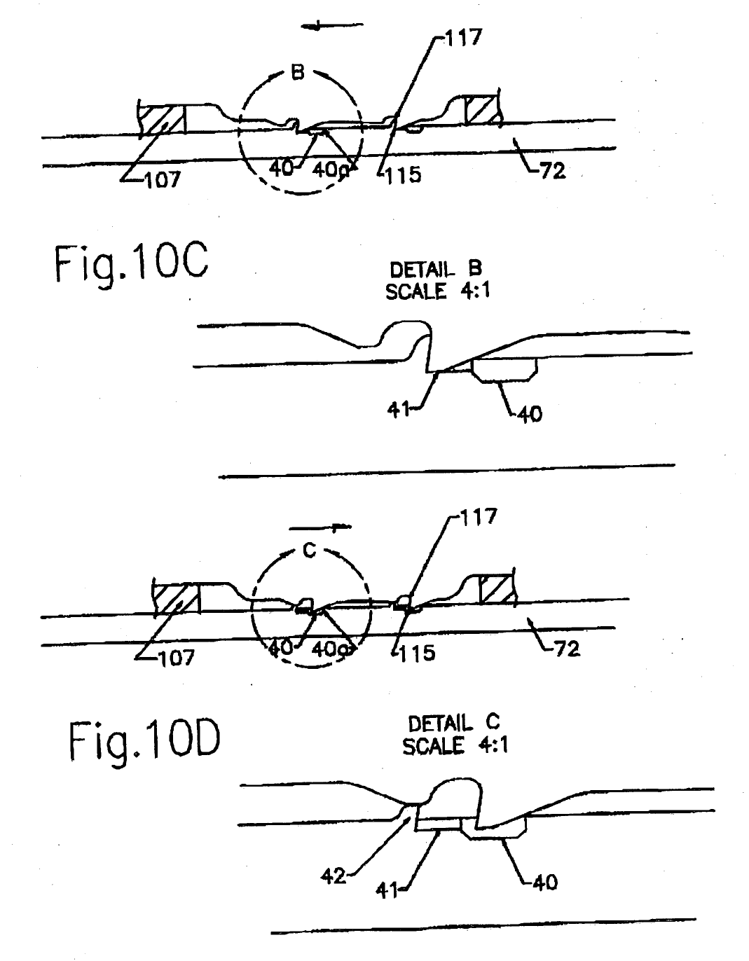

Referring to FIGS. 7B and 10A-10D, when the top die 101a moves down, bottom cover 107 touches material 72 and rests thereon. Extrusion tool rests on bottom cover 107 and edges 115 rest in the depressed portion 40 (FIG. 10A). As top die 101a continues going down, pins 108 inside of tool assembly 120 move down together with base 102 and apply a force on oblong holes 113 on the extrusion tools 110. This force pushes extrusion tools 110 in a downward and sideways direction. Each extrusion tool 110 cannot go down but slide on a generally horizontal direction and extrude material 72 while forming groove 41 (FIG. 10B). The oblong holes 113 on extrusion tools 110 have different orientations to move extrusion tools 110 in different directions, i.e., left or right in FIGS. 7A and 7B. While top die 101 a moves down, extrusion tool 110 causes an extruded portion of plate material 72 to flow into concaved section 117 of extrusion tool 110 to make a bump 73 as shown in FIG. 10C.

When press die 60 moves up, gas springs 111 remain keeping tool assembly 120 pressed on material 72 but pins 108 move up within oblong holes 113 of extrusion tools 110 together with the press die 60. This movement of pins 108 makes extraction tools 110 retract into housing 106. While each extraction tool 110 is retracting under pressure, its lower edge 116 slides and curls the top part of the bumps 73 down toward the depression portion 40, forming a hook or claw 42 (FIG. 10D). Each extraction tool 110 retracts to the original position when the top die 101a reaches the top dead centre of the press. At the end of the press cycle, extrusion tools 110 create several claws 42 on the surface of material 72. When the die 101 opens, material 72 is fed to start a new cycle for a new plate or a new location of the same plate.

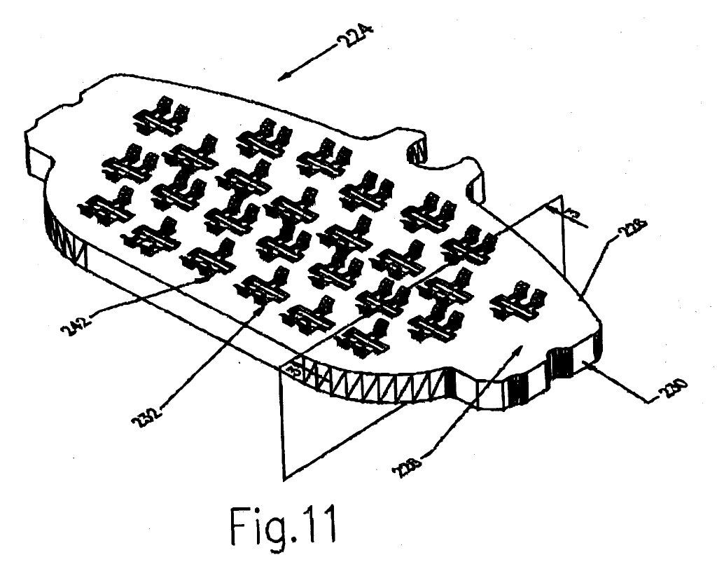

Referring now to FIGS. 11-14, backing plate 224 according to another embodiment of the invention is described.

Backing plate 224 is similar to backing plate 24 shown in FIG. 2. It has a body 226 with a planar top or first surface 228 and an opposing planar bottom or second surface 230. First surface 228 defines one or more retention members 232 for engaging friction material 222 once it has been disposed on first surface 228.

Each retention member 232 in this embodiment comprises a primary depression or depressed portion 240, secondary depressions or grooves 241 and protruding portions or wings 242. Depressed portion 240 and grooves 241 are similar to depressed portion 40 and grooves 41 described referring to FIGS. 2-4A.

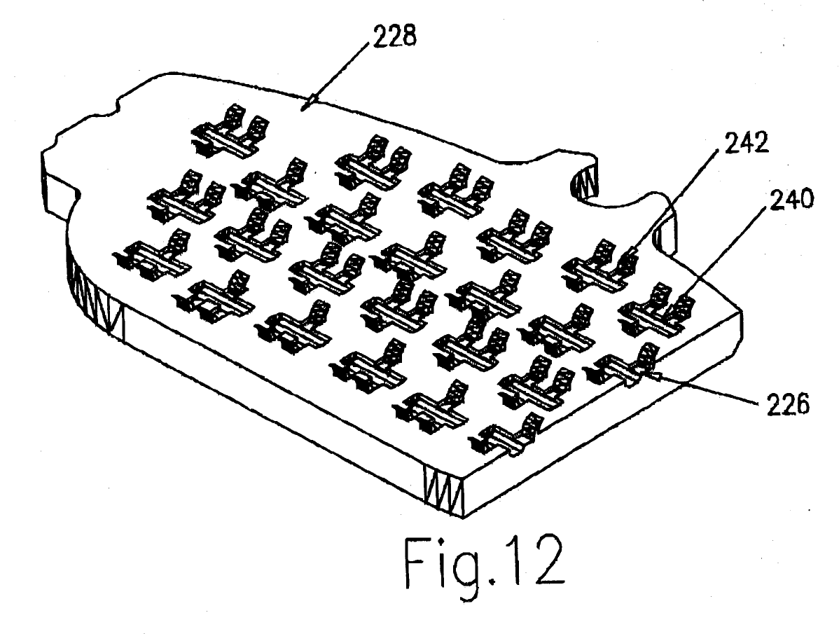

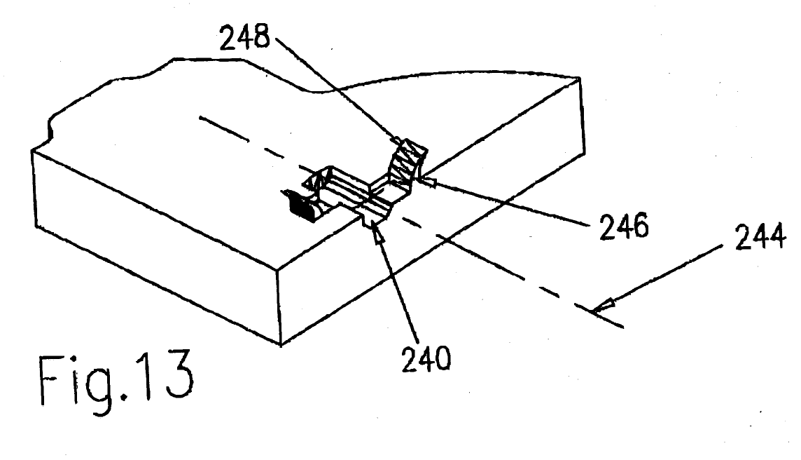

As shown in FIGS. 12 and 13, each wing 242 is formed by cutting and displacing a portion of material from corresponding groove 241, as further described below. Wings 242 extend above first surface 228. Each wing 242 has a proximal end 246 and a free distal end 248. Distal end 248 is curled outwardly and away from its associated depressed portion 240. Wing 242 is integrally connected to first surface 228 of backing plate 224 at distal end 246. The curling of wings 242 is in linear relationship with the body of wings 242 and corresponding groove 241, i.e., wing 242 is not rotated or twisted.

Similar to claws 42 shown in FIGS. 2-4A, wings 242 preferable extend in more than one direction. For example, wings 242 may extend in opposite directions about a horizontal axis 244 of their corresponding depressed portion 240.

Retention members 232 are also arranged on first surface 228 of backing plate 224 in a density and pattern that provides desired retention of friction material 222 while maintaining desired structural integrity of backing plate 28. As shown in FIG. 11, retention members 232 may be arranged in a randomly staggered pattern or in a totally random manner.

In this embodiment, each retention member 232 has three wings 242. However, in different embodiments, a retention member may have more or fewer wings 242. Typically, the more wings 242 on each retention member, the stronger the engagement with the friction material against shearing force, as long as each wing 242 is large and strong enough to withstand forces it is expected to receive. Since each wing 242 is cut from depressed portion 240, it is possible to create wing 242 of more uniform thickness, compared with a member which is curved from a flat surface. Thus, according to this embodiment, it is possible to provide stronger wings, which in turn result in stronger retention of the friction material.

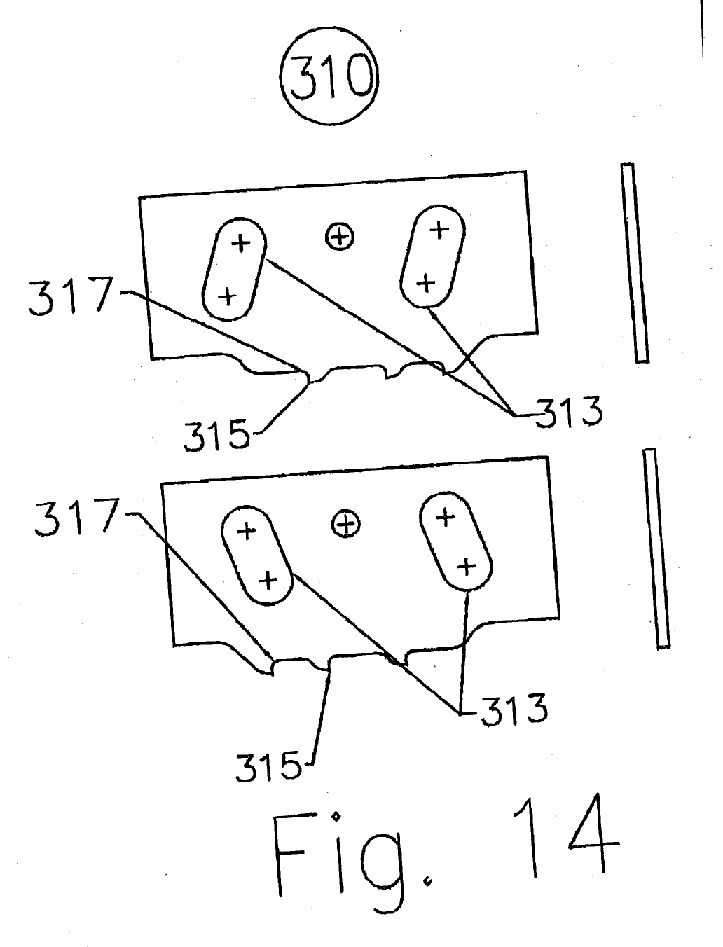

Retention members 232 may be suitably manufactured using similar apparatus shown in FIG. 5 to FIG. 11. Instead of using extrusion tools 110, cutting blades 310 shown in FIG. 14 are used. Cutting blade 310 has oblong holes 313 for the sideway movement in a similar manner to extrusion tool 110 having oblong holes 113 as shown in FIG. 9. Cutting blade 310 has a cutting edge 315 and a flat edge 317. Cutting edge 315 projects below flat edge 317, such that cutting edge 315 enters into depressed portion 240 when flat edge 317 is brought adjacent to the surface of plate material 72. Thus, wing 242 can be cut out from the side wall of depression portion 240, resulting in thick and generally uniform wing 242. While each wing 242 is being formed, a portion of material cut from groove 241 is curled away from depression portion 240.

It is to be understood that various embodiments to the invention have been described. However, the invention encompasses alternative embodiments encompassed by the claims set forth below.

What is claimed is:

1. A backing plate for a friction assembly comprising:
a body having a first surface for receiving a friction material thereon and a second surface opposed to the first surface; and
one or more retention members defined on the first surface, each retention member having:
a primary depression defined in the first surface of the body and having a side wall that extends inward from the first surface towards the second surface;
one or more secondary depressions, each extending within the first surface of the body between a first end and a second end, the first end merging into the side wall of the primary depression; and
one or more protruding members, each extending outwardly away from the first surface of the body at the second end of each secondary depression.

2. The backing plate as claimed in claim 1 wherein each protruding member has a proximal end and a free distal end, the proximal end is contiguous with the second end of the depression, and the distal end is curled towards the primary depression.

3. The backing plate as claimed in claim 2 wherein each protruding member is made by extruding a portion of the body that corresponds to the secondary depression into a claw-like member.

4. The backing plate as claimed in claim 1 wherein each protruding member has a proximal end and a free distal end, the proximal end is integrally connected to the second end of the depression, and the free distal end is curled away from the primary depression.

5. The backing plate as claimed in claim 4 wherein each protruding member is made by cutting and curling a portion of the body that corresponds to the secondary depression.

6. The backing plate as claimed in claim 1 wherein at least one of the retention members has multiple secondary depressions associated with its primary depression, and multiple protruding members associated with the secondary depressions that extend in at least two directions.

7. The backing. plate as claimed in claim 6 wherein the multiple associated protruding members have free ends, curled in more than one direction.

8. The backing. plate as claimed in claim 7 wherein the primary depression defines a horizontal axis along its length, and each protruding member is made by extruding a portion of the body that corresponds to the secondary depression into a claw-like member.

9. The backing plate as claimed in claim 1 wherein
the primary depression extends along a first axis defined on the first surface, and the side wall parallels the first axis; and
the secondary depression defines a second axis between the first end and the second end, and the second axis is at an angle to the first axis.

10. The backing plate as claimed in claim 9 wherein the second axis is approximately perpendicular to the first axis.

11. The backing plate as claimed in claim 1 wherein at least one of the retaining members has multiple secondary depressions and corresponding multiple protruding members, the multiple protruding members alternatively extend in opposite directions.

12. The backing plate as claimed in claim 1 wherein the primary depression has a first depth from the first surface, the secondary depression has a second depth from the first surface, and the second depth is smaller than the first depth.

13. The backing plate as claimed in claim 1 wherein the retention member is integrally formed on the first surface.

14. The backing plate as claimed in claim 1 wherein the depressed portion has a horizontal axis and the extruded portions extend about the horizontal axis.

15. The backing plate as claimed in claim 8 wherein the direction of curling for the extruded portions is in a linear direction.

16. A friction assembly for a brake assembly comprising:
a backing plate having:
a body having a first surface for receiving a friction material thereon and a second surface opposed to the first surface; and
one or more retention members defined on the first surface, each retention member having:
a primary depression defined on the first surface of the body and having a side wall that extends inwardly from the first surface towards the second surface;
one or more secondary depressions, each extending within the first surface of the body between a first end and a second end, the first end merging into the side wall of the primary depression; and
one or more protruding members, each extending outwardly away from the first surface of the body at the second end of each secondary depression; and
a friction material mounted on the first surface of the backing plate so that the friction material is engaged with the at least one retention member.

17. A method for making a backing plate for a friction assembly, the method comprising steps of:
forming a primary depression on a first surface of a body for receiving a friction material thereon, the primary depression defining a side wall extending inwardly from the first surface towards the second surface;
forming a protruding member from the side wall of the primary depression to form a secondary depression that extends within the first surface between a first end and a second end, and a protruding member at the second end of the secondary depression to extend outwardly away from the first surface.

18. The method as claimed in claim 17, wherein the step of forming a protruding member comprising a step of:
extruding plate material from the side wall of the primary depression to form the secondary depression and the protruding member at the second end of the secondary depression to extend outwardly away from the first surface.

19. The method as claimed in claim 18 further comprising a step of curling a free end of the protruding member over the secondary depression.

20. The method as claimed in claim 19 wherein the curling step is carried out continuously at the end of the extruding step.

21. The method as claimed in claim 18 wherein the extruding step forms multiple secondary depressions and protruding members.

22. The method as claimed in claim 21 wherein the extruding step forms multiple secondary depressions and protruding members that extend in more than one direction relative to the primary depression.

23. The method as claimed in claim 18 wherein the extruding step is carried out by an extruding tool having an extruding edge, and the method further comprises a step of positioning the extruding edge into the primary depression prior to starting the extrusion.

24. The method as claimed in claim 22 wherein the extruding step comprises steps of:
sliding the extruding edge to extrude material from the side wall of the primary depression to cause the material flow to form an upright bump; and
curling a free end of the bump towards the primary depression.

25. The method as claimed in claim 17 wherein the primary depression forming step comprises a step of pressing the backing plate material with one or more punches.

26. The method as claimed in claim 17, wherein the step of forming a protruding member comprising a step of:
cutting plate material from the side wall of the primary depression to form the secondary depression and the protruding member at the second end of the secondary depression to extend outwardly from the first surface and curled away from the primary depression.

27. The method as claimed in claim 26 wherein the cutting step forms multiple secondary depressions and protruding members.

28. The method as claimed in claim 27 wherein the cutting step forms multiple secondary depressions and protruding members that extend in more than one direction relative to the primary depression.

29. The method as claimed in claim 26 wherein the cutting step is carried out by a cutting tool having a cutting edge, and the method further comprises a step of positioning the cutting edge into the primary depression prior to starting the cutting of the plate material.

30. The method as claimed in claim 29 wherein the cutting step comprises steps of:
sliding the cutting edge to cut material from the side wall of the primary depression to form a wing; and
curling a free end of the wing around the primary depression.

31. A retention member formation apparatus for forming one or more retention members on a backing plate material, the apparatus comprising:
a primary depression forming apparatus for forming one or more primary depressions on a first surface of a backing plate material which receives a friction material, each primary depression having a bottom and a side wall surrounding the bottom; and
a protruding member forming apparatus for forming from the side wall of the primary depression a secondary depression that extends along the first surface between a first end and a second end, and a protruding member at the second end of the secondary depression to extend outwardly from the first surface.

32. The apparatus as claimed in claim 31 wherein the protruding member forming apparatus comprises
an extrusion apparatus for extruding plate material from the side wall of the primary depression to form the secondary depression and the protruding member at the second end of the secondary depression to extend outwardly from the first surface.

33. The apparatus as claimed in claim 32 wherein the extrusion apparatus has an extruding tool having an extruding edge, and a sliding mechanism for sliding the extruding edge generally in parallel to the first surface of the backing plate.

34. The apparatus as claimed in claim 33 wherein the extrusion apparatus further comprises a positioning mechanism for positioning the extruding edge into the primary depression prior to starting the extrusion.

35. The apparatus as claimed in claim 32 wherein the extruding tool having:
a concave section for receiving a portion of the plate material extruded while forming the secondary depression to form a bump; and
an edge for curling a free end of the bump towards the primary depression.

36. The apparatus as claimed in claim 31 wherein the primary depression forming apparatus comprises a punch for pressing the backing plate material.

37. The apparatus as claimed in claim 31 wherein the protruding member forming apparatus comprises
a cutting apparatus for cutting plate material from the side wall of the primary depression to form the secondary depression and the protruding member at the second end of the secondary depression to extend outwardly from the first surface and curled away from the primary depression.

38. The apparatus as claimed in claim 37 wherein the extrusion apparatus has a cutting tool having a cutting edge, and a sliding mechanism for sliding the cutting tool generally in parallel to the first surface of the backing plate.

39. The apparatus as claimed in claim 38 wherein the cutting apparatus further comprises a positioning mechanism for positioning the cutting edge into the primary depression prior to starting the cutting of the plate material.

40. The apparatus as claimed in claim 38 wherein the cutting tool has a lower surface for curling a free end of the protruding member away from the primary depression.
